(19) United States
(12) Patent Application Publication
(10) Pub. No.: US 2026/0220675 A1
(43) Pub. Date: Jul. 30, 2026

(54) STORE WORK ASSISTANCE APPARATUS, STORE WORK ASSISTANCE METHOD, AND COMPUTER-READABLE MEDIUM

(71) Applicant: NEC Corporation, Tokyo (JP)

(72) Inventors: Tatsuya MATSUKAWA, Tokyo (JP); Yukiya SONOHARA, Tokyo (JP); Mei TAGAWA, Tokyo (JP)

(73) Assignee: NEC Corporation, Tokyo (JP)

(21) Appl. No.: 19/146,271

(22) PCT Filed: Mar. 23, 2023
(86) PCT No.: PCT/JP2023/011419

§ 371 Date: Jul. 8, 2025

(51) Int. Cl. G06Q 30/0601

(52) U.S. Cl. CPC G06Q 30/0601

(57) ABSTRACT

A guideline information acquisition unit acquires guideline information in which a guideline on a layout design of a product shelf in a store is described in a natural language. A layout generation unit generates a layout proposal for the product shelf in the store on the basis of the guideline information and of a trained model for generating a layout of the product shelf in the store from the guideline information. A layout presentation unit presents the generated layout proposal to a user.

### TECHNICAL FIELD

The present disclosure relates to a store work assistance apparatus, a store work assistance method, and a computer-readable medium.

### BACKGROUND ART

As a related technique, PTL 1 discloses a planogram management system. The planogram management system presents a layout of shelves in a store and the sales results for each shelf to a product placement planner. The product placement planner determines which shelf to change the product placement on, based on this presented result. When the product placement planner designates one shelf, the planogram management system presents sales results of individual products on the designated shelf to the product placement planner. The product placement planner determines a product to be deleted or a product to be newly added, based on this presented result. The planogram management system automatically determines the number of displayed pieces of individual products, based on the properties of the products. The planogram management system organizes knowledge about product placement into a knowledge base and automatically determines placement of individual products on display shelves, using this knowledge.

### CITATION LIST

### Patent Literature

PTL 1: JP 63-261462 A

### SUMMARY OF INVENTION

### Technical Problem

In PTL 1, knowledge about product placement possessed by a skilled person is organized into a knowledge base, and the placement of individual products on the display shelves is automatically determined using the organized knowledge. However, in PTL 1, the product placement planner is required to designate a product to be deleted from a shelf and a product to be newly added. For this reason, the planogram management system described in PTL 1 has a disadvantage that the product placement planner is required to have knowledge about products and the sales of the products and is not allowed to easily change or design the layout.

In view of the above circumstances, an object of the present disclosure is to provide a store work assistance apparatus, a store work assistance method, and a computer-readable medium capable of presenting a desired layout to a user even if the user does not have sophisticated knowledge.

### Solution to Problem

In order to achieve the above object, the present disclosure provides a store work assistance apparatus as a first aspect. The store work assistance apparatus includes a guideline information acquisition unit that acquires guideline information in which a guideline on a layout design of a product shelf in a store is described in a natural language, a layout generation unit that generates a layout proposal for the product shelf in the store, based on the guideline information and a trained model for generating a layout of the product shelf in the store from the guideline information, and a layout presentation unit that presents the generated layout proposal to a user.

The present disclosure provides a store work assistance method as a second aspect. The store work assistance method includes acquiring guideline information in which a guideline on a layout design of a product shelf in a store is described in a natural language, generating a layout proposal for the product shelf in the store, based on the guideline information and a trained model for generating a layout of the product shelf in the store from the guideline information, and presenting the generated layout proposal to a user.

The present disclosure provides a computer-readable medium as a third aspect. The computer-readable medium stores a program for causing a computer to execute a process including acquiring guideline information in which a guideline on a layout design of a product shelf in a store is described in a natural language, generating a layout proposal for the product shelf in the store, based on the guideline information and a trained model for generating a layout of the product shelf in the store from the guideline information, and presenting the generated layout proposal to a user.

### Advantageous Effects of Invention

In the store work assistance apparatus, the store work assistance method, and the computer-readable medium according to the present disclosure, the user is allowed to easily determine a layout even if the user does not have sophisticated knowledge.

### BRIEF DESCRIPTION OF DRAWINGS

FIG. 1 is a block diagram illustrating an outline of a configuration example of a store work assistance apparatus according to the present disclosure.

FIG. 2 is a block diagram illustrating a store work assistance apparatus according to an example embodiment of the present disclosure.

FIG. 3 is a schematic diagram illustrating an input and an output of a trained model.

FIG. 4 is a schematic diagram schematically illustrating an example of movement of a product shelf.

FIG. 5 is a flowchart illustrating an operation procedure of the store work assistance apparatus.

FIG. 6 is a block diagram illustrating a configuration example of a computer apparatus.

### EXAMPLE EMBODIMENT

Prior to describing example embodiments of the present disclosure, an overview of the present disclosure will be given. FIG. 1 illustrates an outline of a configuration example of a store work assistance apparatus according to the present disclosure. A store work assistance apparatus 10 includes a guideline information acquisition unit 11, a layout generation unit 12, and a layout presentation unit 13.

The guideline information acquisition unit 11 acquires guideline information in which a guideline on a layout design of a product shelf in a store is described in a natural language. The layout generation unit 12 generates a layout proposal for the product shelf in the store, based on the guideline information and a trained model for generating a layout of the product shelf in the store from the guideline information. The layout presentation unit 13 presents the generated layout proposal to a user.

In the present disclosure, the guideline information acquisition unit 11 acquires guideline information in which a guideline on a layout design of a product shelf is described in a natural language. The layout generation unit 12 generates a layout proposal, based on the guideline information and the trained model. In the present disclosure, the layout generation unit 12 can generate a layout proposal according to the acquired guideline information, using the trained model. Therefore, the store work assistance apparatus 10 according to the present disclosure can present a desired layout to the user even if the user does not have sophisticated knowledge.

Hereinafter, example embodiments of the present disclosure will be described in detail with reference to the drawings. Note that, in the following description and drawings, omission and simplification will be made as appropriate for clarity of description. The same elements and similar elements are denoted by the same reference signs in the following drawings, and repeated description will be omitted, as necessary.

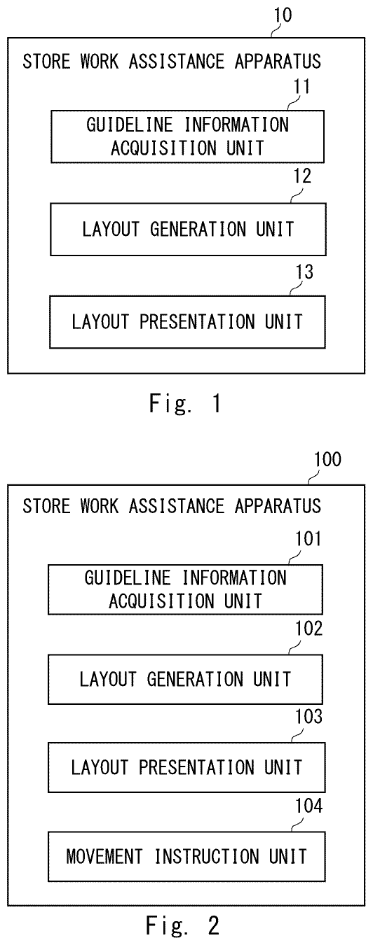

FIG. 2 illustrates a store work assistance apparatus according to an example embodiment of the present disclosure. A store work assistance apparatus 100 includes a guideline information acquisition unit 101, a layout generation unit 102, a layout presentation unit 103, and a movement instruction unit 104. The store work assistance apparatus 100 can be physically configured as an apparatus including one or more processors and one or more memories. At least some of functions of the units in the store work assistance apparatus 100 can be implemented, for example, in such a way that a processor executes processing in accordance with a command read from a memory. The store work assistance apparatus 100 is related to the store work assistance apparatus 10 illustrated in FIG. 1.

The guideline information acquisition unit 101 acquires guideline information that serves as a guideline for designing or changing a layout of a product shelf in a store. In the present example embodiment, the guideline information is described in a natural language. The user inputs a character string or text data indicating the guideline information and described in a natural language, to the guideline information acquisition unit 101, for example, using an input device such as a keyboard. The guideline information acquisition unit 101 is related to the guideline information acquisition unit 11 illustrated in FIG. 1.

The layout design or change is conducted, for example, in a case where it is needed to improve sales of a specified product. The layout design or change may be conducted to enlarge an eating space or secure an evacuation space in the event of a disaster. The guideline information includes, for example, a name or a type of a product for which sales are to be increased. The guideline information may include the type and magnitude of the disaster that occurred in relation to the area where the store is located. For example, the user can input, as the guideline information, a purpose of a layout change in the store or a request for a new layout, such as wanting to improve sales of a specified product or product category or wanting to secure an eating space.

In the present example embodiment, the layout change can be implemented, for example, by changing the position of a product shelf on which a product is displayed. The layout change can also be implemented by changing a product displayed on a product shelf. The layout change may be implemented by increasing or decreasing the number of product shelves placed in the selling area of the store.

The layout generation unit 102 generates a layout proposal for the product shelf in the store, based on the guideline information acquired by the guideline information acquisition unit 101 and a trained model for generating a layout of the product shelf in the store from the guideline information. The trained model is, for example, a model to which the guideline information is input and from which a layout proposal according to the guideline information is output. The trained model is generated, for example, by learning a relationship between a position in a store of a product shelf on which each product is displayed, and sales of each product. The trained model is also referred to as an artificial intelligence (AI) model.

The layout generation unit 102 may generate the layout proposal, based on store characteristic information indicating characteristics of each store, as well as the guideline information. The store characteristic information may include, for example, a population density of an area where a store is located, and a regional characteristic of a place where a store is located, such as a shopping street or a residential street. The store characteristic information may include information indicating whether the place where the store is located is land with a hard ground or land with a loose ground. The store characteristic information may also include information indicating whether the place where the store is located is a low land with a risk of flooding during heavy rain. The layout generation unit 102 may generate the layout proposal, based on time information as well as the guideline information and the store characteristic information. The time information includes, for example, information regarding a time to which the layout of the product shelf is applied, such as morning, daytime, evening, or night.

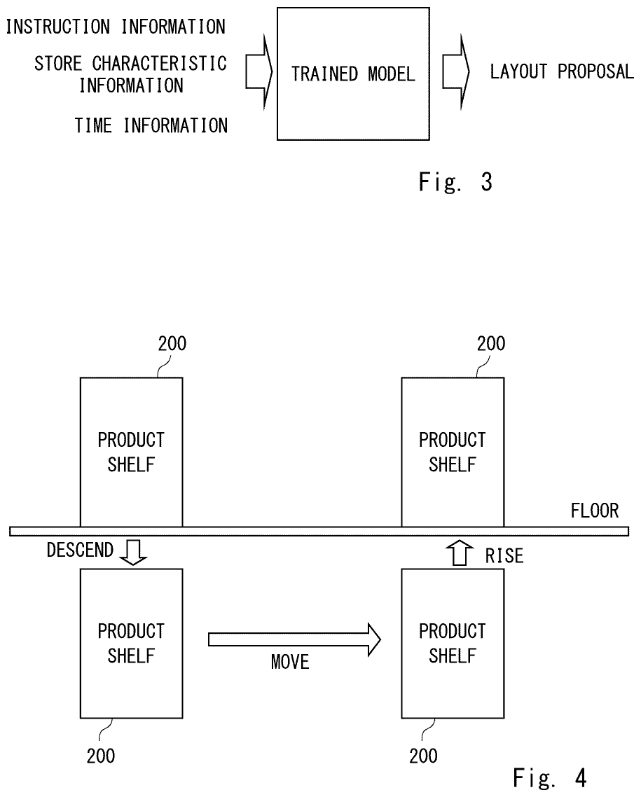

FIG. 3 illustrates an input and an output of the trained model. The layout generation unit 102 inputs the guideline information described in a natural language, the store characteristic information, and the time information to the trained model. The trained model is generated by learning learning data in a learning apparatus (not illustrated). The learning data includes, for example, sales data of a product, the class of a product, the position of a product shelf in a store, the number of customers who visit a store, a flow of people in a store, and distribution for each attribute of customers in a store. The learning data may include weather, temperature, and nearby event information. The trained model outputs a layout proposal according to the input information.

The learning apparatus generates the trained model by learning sales information for each product, the class of a product, the position of a product shelf, information on an unsold product, and the like, for example. In addition to the information described above, the learning apparatus may generate the trained model by learning information on distribution of customers in a store for each purchaser attribute such as gender and age. For example, guideline information including a request of “wanting to grow sales of confectionery” is input to the trained model. The trained model can output a layout proposal for a product shelf intended to fulfill the input request in response to the input guideline information.

Alternatively, guideline information including a request of “wanting to secure an eating space during lunch time” may be input to the trained model. In that case, the trained model can output a layout proposal for clearing up product shelves on which products that are not in demand in the lunch time, such as products not relating to food, are displayed and securing a space for eating in. The product shelf placed in the store may be configured to be transformable and may be configured to be usable as a table or a chair in an eating space or the like. In this case, in the layout proposal output from the trained model, some product shelves may be transformed into and used in a table mode or a chair mode.

The learning apparatus may learn information associated with a disaster that occurred in the past to generate a trained model. The learning apparatus learns, for example, information such as the type of disaster that occurred in the past, the magnitude of the disaster, the number of people evacuated to evacuation centers such as community halls, and the population density of the area. The learning apparatus may learn information regarding the location of a store, as well as the information associated with a disaster. For example, the learning apparatus may learn information on a surrounding environment such as being likely to undergo flooding and having weak ground, for example. Furthermore, the learning apparatus may learn information on a product that is in demand in the event of a disaster, a product to be provided to neighboring residents, and the like.

For example, guideline information such as “An earthquake has happened. It is seismic intensity 4.” is input to the trained model. Alternatively, guideline information such as “flood damage has occurred” or “a typhoon is approaching” may be input to the trained model. The trained model can predict the number of evacuees according to the type and magnitude of the disaster and generate a layout proposal for securing a space for evacuation in the store according to the predicted number of evacuees. Alternatively, the trained model may generate a layout proposal for selling products that are in great demand in the event of a disaster on a product shelf near the store entrance.

Here, the layout proposal generated by the layout generation unit 102 is not required to be the layout proposal for product shelves for the entire region in the store. For example, the layout generation unit 102 may fix the position of a product shelf for a part of the region and generate a layout proposal in accordance with the guideline information for other parts of the region.

The layout presentation unit 103 presents the layout proposal generated by the layout generation unit 102 to the user as a layout proposal advised in response to the input guideline information. The layout presentation unit 103 displays the layout proposal on a screen of a display device, for example. The user may be allowed to make modifications to the displayed layout proposal. When the user approves the suggested layout proposal, the layout presentation unit 103 outputs the approved layout proposal to the movement instruction unit 104.

In the present example embodiment, it is assumed that the product shelf placed in the store is configured to be autonomously movable. For example, a motor as a drive source may be incorporated in the product shelf. The product shelf may be divided into a plurality of blocks in the horizontal direction or the vertical direction and may be configured to be expandable and contractable by changing the number of blocks to be coupled. The movement instruction unit 104 moves the product shelf in accordance with the layout proposal generated by the layout generation unit 102.

For example, an identifier is allocated to a product shelf, and an address is allocated to each place in the store. The movement instruction unit 104 transmits, for example, a set of the identifier and the address of the movement destination place to the product shelf. Each product shelf specifies a movement route, based on the address of the movement starting point and the address of the movement destination, and moves to the place at the address of the movement destination along the movement route. When the product shelf is moved, a layout consistent with the layout proposal can be implemented in the store. The movement instruction unit 104 is also referred to as a shelf movement unit.

FIG. 4 schematically illustrates an example of movement of a product shelf. In the store, a product shelf 200 once descends to an underfloor space and moves in the underfloor space. The shelf movement is completed by raising the product shelf 200 on the floor at the movement destination place. The movement destination place may be a backyard. By moving the product shelf 200, the placement of products, that is, the selling area can be altered. The product shelf 200 may send position information. The movement instruction unit 104 may receive the position information from a plurality of product shelves in the store and manage which product shelf is placed in which place.

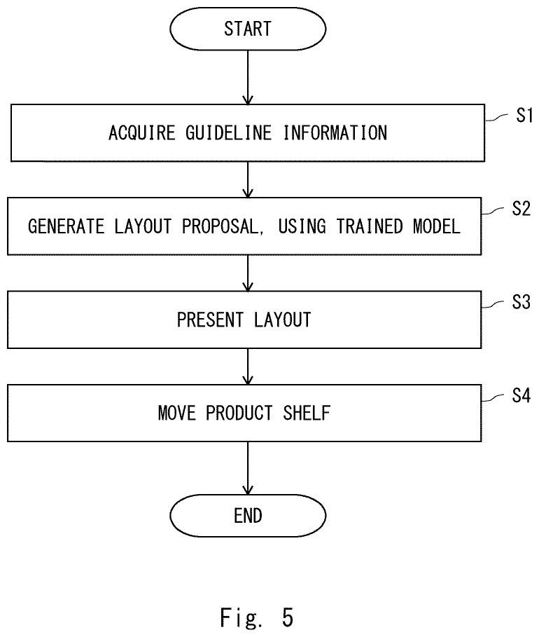

Next, an operation procedure will be described. FIG. 5 illustrates an operation procedure of the store work assistance apparatus 100. The operation procedure of the store work assistance apparatus 100 is related to the store work assistance method. The guideline information acquisition unit 101 acquires the guideline information described in a natural language (step S1). The layout generation unit 102 generates a layout proposal according to the guideline information acquired in step S1, using the trained model (step S2).

The layout presentation unit 103 presents the layout proposal generated in step S2 to the user (step S3). The user approves the presented layout proposal. The user may modify the presented layout proposal. The movement instruction unit 104 moves a product shelf in accordance with the layout proposal approved by the user or the layout proposal modified by the user (step S4).

In the present example embodiment, the layout generation unit 102 generates a layout proposal, based on the guideline information described in a natural language and the trained model. In the present example embodiment, when the user inputs a request of wanting to obtain a certain specific layout to the store work assistance apparatus 100, the store work assistance apparatus 100 can present a layout proposal recommended in response to the input request to the user. By providing the store work assistance apparatus 100 with the guideline information described in a natural language in an ambiguous way to some extent, the user can be presented with a layout proposal according to the provided guideline information. The user can also easily conduct layout design even without having sophisticated knowledge.

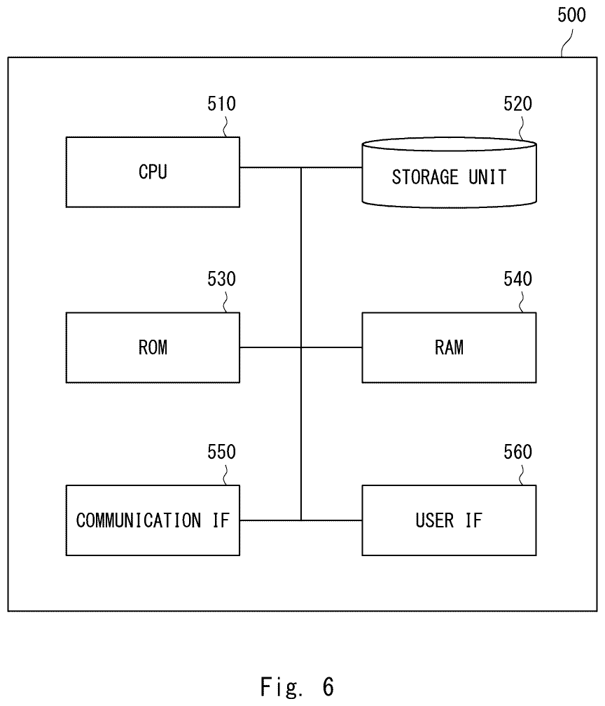

In the present disclosure, the store work assistance apparatus 100 can be configured using a computer apparatus or a server apparatus. FIG. 6 illustrates a configuration example of a computer apparatus that can be used in the store work assistance apparatus 100. A computer apparatus 500 includes a control unit (central processing unit (CPU)) 510, a storage unit 520, a read only memory (ROM) 530, a random access memory (RAM) 540, a communication interface (IF) 550, and a user interface (IF) 560.

The communication interface 550 is an interface for connecting the computer apparatus 500 to a communication network via wired communication means, wireless communication means, or the like. The user interface 560 includes, for example, a display unit such as a display. The user interface 560 includes input units such as a keyboard, a mouse, and a touch panel.

The storage unit 520 is an auxiliary storage device that can retain various types of data. The storage unit 520 is not necessarily a part of the computer apparatus 500 and may be an external storage device or a cloud storage connected to the computer apparatus 500 via a network.

The ROM 530 is a nonvolatile storage device. For example, a semiconductor storage device such as a flash memory that has a relatively compact capacity may be used for the ROM 530. A program executed by the CPU 510 can be stored in the storage unit 520 or the ROM 530. The storage unit 520 or the ROM 530 stores, for example, various programs for implementing the function of each unit in the store work assistance apparatus 100.

The program includes a group of commands (or software code) for causing the computer to perform one or more functions described in the example embodiments when the program is loaded into the computer. The program may be stored in a non-transitory computer-readable medium or in a tangible storage medium. As an example and not by way of limitation, the computer-readable medium or the tangible storage medium includes a RAM, a ROM, a flash memory, a solid-state drive (SSD) or any other memory technique, a compact disc (CD), a digital versatile disc (DVD), a Blu-ray (registered trademark) disc or any other optical disc storage, a magnetic cassette, a magnetic tape, a magnetic disk storage, or any other magnetic storage device. The program may be transmitted on a transitory computer-readable medium or a communication medium. As an example and not by way of limitation, the transitory computer-readable medium or the communication medium includes an electric signal, an optical signal, an acoustic signal, or any other form of propagation signal.

The RAM 540 is a volatile storage device. Various semiconductor memory devices such as a dynamic random access memory (DRAM) or a static random access memory (SRAM) are used for the RAM 540. The RAM 540 can be used as an internal buffer that temporarily stores data or the like. The CPU 510 loads a program stored in the storage unit 520 or the ROM 530 into the RAM 540 and executes the loaded program. The function of each unit in the store work assistance apparatus 100 can be implemented by the CPU 510 executing a program. The CPU 510 may include an internal buffer that can temporarily store data or the like.

In each of the above example embodiments, the store work assistance apparatus 100 is not required to be physically configured as a single apparatus. The store work assistance apparatus 100 may be configured using a plurality of physically separated apparatuses. For example, the store work assistance apparatus 100 may be separated into an apparatus including the guideline information acquisition unit 101, the layout generation unit 102, and the layout presentation unit 103, and an apparatus including the movement instruction unit 104. In this case, an apparatus including the guideline information acquisition unit 101, the layout generation unit 102, and the layout presentation unit 103 can be referred to as a layout presentation apparatus.

While the present disclosure has been particularly shown and described with reference to example embodiments thereof, the present disclosure is not limited to these example embodiments. The present disclosure also includes changes or modifications made to the above example embodiments without departing from the spirit and scope of the present disclosure as defined by the claims.

### REFERENCE SIGNS LIST

10 store work assistance apparatus
11 guideline information acquisition unit
12 layout generation unit
13 layout presentation unit
100 store work assistance apparatus
101 guideline information acquisition unit
102 layout generation unit
103 layout presentation unit
104 movement instruction unit
200 product shelf
500 computer apparatus
510 control unit
520 storage unit
530 ROM
540 RAM
550 communication interface
560 user interface

What is claimed is:

1. A store work assistance apparatus comprising:
at least one memory storing instructions; and
at least one processor configured to execute the instructions to:
acquire guideline information in which a guideline on a layout design of a product shelf in a store is described in a natural language;
generate a layout proposal for the product shelf in the store, based on the guideline information and a trained model for generating a layout of the product shelf in the store from the guideline information; and
present the generated layout proposal to a user.

2. The store work assistance apparatus according to claim 1, wherein the trained model is a model to which the guideline information is input and from which the layout proposal is output.

3. The store work assistance apparatus according to claim 1, wherein the at least one processor is configured to execute the instructions to generate the layout proposal, based on store characteristic information indicating a characteristic of the store, as well as the guideline information.

4. The store work assistance apparatus according to claim 1, wherein the guideline information includes a name or a type of a product for which sales are to be increased.

5. The store work assistance apparatus according to claim 1, 3, wherein the guideline information includes a type and magnitude of a disaster that occurred in relation to an area where the store is located.

6. The store work assistance apparatus according to claim 1, the at least one processor is configured to execute the instructions to move the product shelf placed in the store and configured to be autonomously movable, in accordance with the generated layout proposal.

7. A store work assistance method comprising:
acquiring guideline information in which a guideline on a layout design of a product shelf in a store is described in a natural language;
generating a layout proposal for the product shelf in the store, based on the guideline information and a trained model for generating a layout of the product shelf in the store from the guideline information; and
presenting the generated layout proposal to a user.

8. A non-transitory computer-readable medium storing a program for causing a computer to execute a process comprising:
acquiring guideline information in which a guideline on a layout design of a product shelf in a store is described in a natural language;
generating a layout proposal for the product shelf in the store, based on the guideline information and a trained model for generating a layout of the product shelf in the store from the guideline information; and
presenting the generated layout proposal to a user.
